(19) United States
(12) Patent Application Publication
(10) Pub. No.: US 2026/0225771 A1
(43) Pub. Date: Aug. 6, 2026

(54) CHEMICAL RESISTANT FITTINGS

(71) Applicant: CDF Corporation, Plymouth, MA (US)

(72) Inventor: Joseph Sullivan, JR., Plymouth, MA (US)

(21) Appl. No.: 19/445,870

(22) Filed: Jan. 12, 2026

Related U.S. Application Data
(60) Provisional application No. 63/750,866, filed on Jan. 29, 2025.

(51) Int. Cl. B65D 41/04; B29D 99/00; B29K 23/00; B29K 77/00; B29L 31/56; B32B 1/08; B32B 27/08; B32B 27/30; B32B 27/32; B32B 27/34

(52) U.S. Cl. CPC B65D 41/045; B29D 99/0096; B32B 1/08; B32B 27/08; B32B 27/306; B32B 27/32; B32B 27/34; B29K 2023/0608; B29K 2023/086; B29K 2077/00; B29K 2995/0058; B29L 2031/565; B32B 2250/02; B32B 2250/24; B32B 2307/714; B32B 2435/02

(57) ABSTRACT

A fitting that is configured to be coupled to a container liner includes a plastic composite having a chemical resistant material. The fitting is injection molded.

### CROSS-REFERENCE TO RELATED APPLICATION(S)

This application claims priority to U.S. Provisional Ser. No. 63/750,866, filed 29 Jan. 2025, the entire disclosure of which is hereby incorporated by reference.

### TECHNICAL FIELD

The present disclosure relates generally to a sealing structure of a container and liner such as those that hold chemicals or the like and more particularly a fitting for the liner which enables access to the contents of the liner.

### BACKGROUND

Current storage systems and containers, particularly for chemicals, for example, suffer from a variety of drawbacks. One particular drawback relates to environmental and/or health concerns due to fluorination of the container and/or liner.

Fluorination plays a prominent role in the packaging industry and its advocates consider it to be a critical process to create a successful barrier against the leakage of aggressive substances. Yet, the most utilized types of fluorinations create perfluoroalkyl and polyfluoroalkyl substances (“PFAS”). Proponents of fluorination argue that the PFAS formed as part of the barrier process is negligible and does not affect the contents housed within fluorinated HDPE containers. However, the presence of PFAS in fluorinated high density polyethylene (“HDPE”) is not a novel issue and has been demonstrated before. Furthermore, studies indicate that there is a high rate of transferability of the PFAS generated by the fluorination process into the contents of fluorinated HDPE containers, including food products.

These and other drawbacks of current chemical resistant containers and liners are addressed by the present application. For example, even if the container and/or liner are manufactured with chemical resistant materials, the fittings are not. While the disclosure uses chemical storage, shipping, handling, and use as an example, the container disclosed herein is not limited to use with chemicals and can be used for a variety of contents.

### SUMMARY

Embodiments disclosed herein include systems, assemblies, and methods for storing materials, including chemicals and hazardous materials. Specifically, the embodiments are directed to fittings coupled to liners and container materials, where the fittings are chemical resistant. In some embodiments, fitting configured to be coupled to a container liner can include a plastic composite comprising a chemical resistant material. The fitting can be injection molded. In an example, the chemical resistant material can include ethylene vinyl alcohol. In some examples, the plastic composite can include at least one of a nylon, low-density polyethylene, linear low-density polyethylene a high-density polyethylene, polypropylene, or a polyamide. The fitting can be heat sealed to the liner. In some examples, the fitting and the liner are thermoformed. In other examples, the fitting and the liner are sealed with a sealant.

In some examples, the fitting can include a threaded connector. In some examples, the fitting can include an extendable connector. In yet other examples, the fitting can include a press-fit connector. The container liner can include at least two layers. In some examples, the container liner includes at least one of ethylene vinyl alcohol and polyamide. In an example, the fitting can include comprises an oxygen transmission rate of less than about 1 cc/m².

In some examples, a method for forming a multi-layer liner with a fitting can include co-extruding the multi-layered liner, injection molding the fitting, and coupling the fitting to the multi-layered liner. The fitting can include greater than about 10 wt. % of ethylene vinyl alcohol. In an example, co-extruding the multi-layered liner can include combining at least a polyethylene and ethylene vinyl alcohol into a single product by forcing them through a die. In an example, at least one layer of the multi-layer liner comprises greater than about 10 wt. % of ethylene vinyl alcohol. In some examples, coupling the fitting to the multi-layered liner can include at least one of thermoforming, heat-sealing, or thermosetting the multi-layer liner and the fitting together.

In some examples, a method for forming a fitting can include melting a resin material and injecting the resin material into a cavity of an injection molding device to form a fitting. The resin material can include a polyethylene and an ethylene vinyl alcohol, and the fitting can include greater than about 10 wt. % of ethylene vinyl alcohol. In some examples, the fitting can include an oxygen transmission rate of less than about 1 cc/m². In some examples, the method can further include air cooling the fitting, opening the mold, and operating ejector pins to contact the fitting and release the fitting from the mold. In an example, the fitting can include at least one of a threaded connector, an extendable connector, or a press-fit connector.

Features from any of the disclosed embodiments may be used in combination with one another, without limitation. In addition, other features and advantages of the present disclosure will become apparent to those of ordinary skill in the art through consideration of the following detailed description and the accompanying drawings.

### BRIEF DESCRIPTION OF THE DRAWINGS

The drawings illustrate several embodiments of the present disclosure, wherein identical reference numerals refer to identical or similar elements or features in different views or embodiments shown in the drawings.

FIG. 1A is a cross-sectional view of an example fitting comprising a separated threaded connector and a cap.

FIG. 1B is a cross-sectional view of the fitting of FIG. 1A with the threaded connector and cap coupled together.

FIG. 1C is a cross-sectional view of an example fitting comprising a separated press-fit connector and a cap.

FIG. 1D is a cross-sectional view of the fitting of FIG. 1C with the press-fit connector and cap coupled together.

FIG. 2A is a perspective view of a fitting and container, the fitting comprising an extendable connector and a cap.

FIG. 2B is a perspective view of a fitting and liner, the fitting comprising a press-fit connector.

FIG. 3 is a block flow diagram for a method for forming a multi-layer liner with a fitting.

FIG. 4 is a block flow diagram for forming a fitting.

### DETAILED DESCRIPTION

Embodiments disclosed herein are related to assemblies, systems, and methods of producing a container or container liner having fittings that are chemical resistant. The assemblies, systems, and methods of producing a chemical resistant fitting include a fitting configured to be coupled to a container liner that can be an opening for the liner to fill and empty the liner and ensure that all of the components of the assembly are chemical resistant to better protect the health of users and the environment. In some examples, the fittings can be attached to a liner that is also chemical resistant and configured to, at least in part, contain food products, agricultural chemicals, flavors and fragrances, industrial chemicals, healthcare products, and beauty products, and provide an alternative to fluorination.

Specific embodiments of the disclosure are described with reference to the accompanying drawings. This disclosure may, however, be embodied in many different forms and should not be construed as limited to the embodiments set forth herein; rather, these embodiments are provided so that this disclosure will be thorough and complete, and conveys the scope of the disclosure to those skilled in the art. The terminology used in the detailed description of the embodiments illustrated in the accompanying drawings is not intended to be limiting of the disclosure.

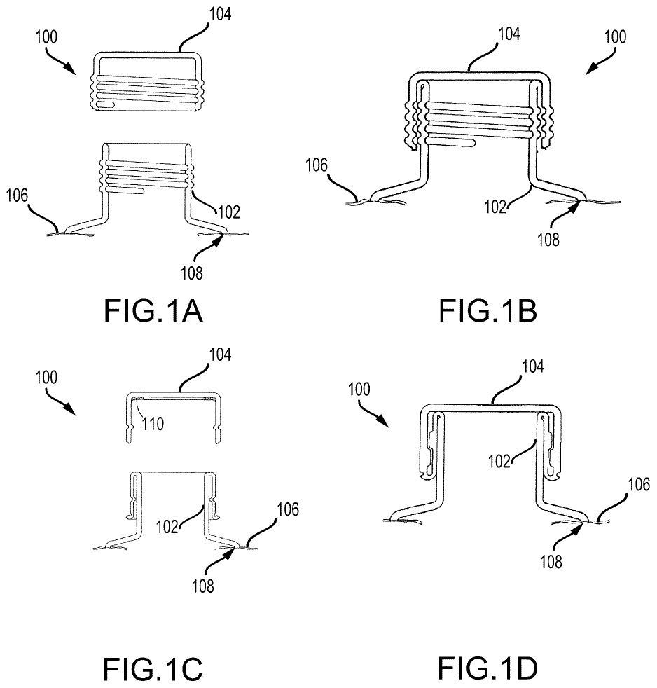

FIGS. 1A-1D show example fittings 100 that can be used to couple to a liner. Generally, in some examples, the fitting 100 can include a spout 102 that is configured to be coupled to a cap 104. The fitting is configured to be coupled to a liner 106 and sealed to the liner at an interface 108. For example, FIG. 1A shows the fitting 100 as a threaded connector. A threaded connector is a type of fitting that uses a screw-like mechanism to join two pieces together, where the spout 102 includes male threads (protruding) and the cap 104 has female threads (recessed), allowing them to be screwed tightly into each other to create a secure connection. FIG. 1B shows the spout 102 and the cap 104 coupled together. In some examples, the fitting 100 can include a plug. For example, the fitting 100 as a threaded connector can include the spout 102 having female threads and the plug having male threads, where the spout 102 and the plug can be screwed together to create a secure connection.

FIGS. 1C and 1D are similar with a spout 102 and cap 104. The spout is coupled to the liner 106 at interface 108. In some examples, the fitting 100 can include a press-fit connector. In a press-fit connector the cap 104 can be coupled to the spout 102 via friction. The cap 104 is pressed directly onto the spout 102 and the fitting uses an interference fit to secure the connection between the spout 102 and cap 104. In some examples, the cap 104 can include a seal 110. In an example, the seal 110 can include a thin piece of material, often made of foil or plastic, placed inside the cap 104 of a container to create a tight seal around the opening of the spout 102, preventing leaks and protecting the material inside the liner or container. In some examples, the seal 100 can include a tamper-evident feature that can break when the cap 104 is removed. In some examples, the seal 110 can be coupled to the spout at the opening instead of within the cap as shown.

In some examples, the fitting 100 can be manufactured from a plastic composite having a chemical resistant material therein. The plastic composite fitting can be injection molded in some examples. In some examples, the chemical resistant material can include ethylene vinyl alcohol. Ethylene vinyl alcohol (EVOH) is a formal copolymer of ethylene and vinyl alcohol. Because the latter monomer mainly exists as its tautomer acetaldehyde, the copolymer is prepared by polymerization of ethylene and vinyl acetate to give the ethylene vinyl acetate (EVA) copolymer followed by hydrolysis. EVOH copolymer is defined by the mole % ethylene content: lower ethylene content grades have higher barrier properties; higher ethylene content grades have lower temperatures for extrusion. EVOH is known and used as an oxygen barrier in food packaging. It is better than other plastics at keeping air out and flavors in, is highly transparent, weather resistant, oil and solvent resistant, flexible, moldable, and recyclable.

In some examples, the plastic composite fitting can also include a nylon material. Nylon is a high-performance plastic material made from a synthetic polymer. The name nylons refer to the group of plastics known as polyamides. Nylons are typified by amide groups and encompass a range of material types (e.g., Nylon 6,6; Nylon 6,12; Nylon 4,6; Nylon 6; Nylon 12 etc.), providing an extremely broad range of available properties. In some examples, the plastic composite fitting can include a high-density polyethylene or a polypropylene. HDPE is a strong, durable, lightweight, and chemically resistant plastic material that is easy to fabricate and weld using thermoplastic welding equipment. Polypropylene (PP) is also a thermoplastic polymer that is used in a variety of applications. Its properties are similar to polyethylene, but it is slightly harder and more heat resistant. PP has a high chemical resistance.

As noted above, the fitting 100 can be coupled to the liner 106 at interface 108. In some examples, the liner 106 can include either a single layer of plastic material or can be a multi-layer material. In some examples the liner 106 can include EVOH film. In some examples, the cap 104 can be made of nylon. In some examples, the cap 104 can be made of EVOH.

In some examples, through the process of extrusion lamination, an EVOH film can be wound around a roll, fed through a die system, and laminated and bonded to a material being extruded from the die. Using this process, the EVOH film can be laminated to an outer surface of the extruded sheet whether it is PP, PE, HDPE, etc. The configuration of EVOH on the surface of a monolayer sheet can provide barrier properties, however barrier properties can be dramatically improved by the number of layers the sheets of material. In some examples, the liner 106 can include at least two layers. In some examples, the EVOH film can be laminated as a layer disposed within the extruded sheet whether it is PP, PE, HPDE, etc. For example, the EVOH film can be disposed between two layers of the PP, PE, HDPE, etc.

In some examples, the fitting 100 can include an oxygen transmission rate of less than 1cc/m2 . Oxygen transmission rate is defined as the steady state rate at which oxygen gas permeates through a material at specified conditions of temperature and relative humidity. Standard test conditions are 73° F. (23° C.) and 0% relative humidity. Once air has been replaced in or eliminated from the package, there must be an adequate oxygen barrier and sufficient seal integrity to maintain a low oxygen concentration inside it. Otherwise, the driving force created by the oxygen partial pressure differences (21% outside the bag and 0-2% inside the bag) will cause an ingress of oxygen and destroy the benefit of removing it in the first place. Oxygen transmission rate values are used to compare the relative oxygen barrier capabilities of packaging materials. In some examples the fitting 100 can include an oxygen transmission rate of less than 0.8 cc/m2 , less than 0.6 cc/m2 , less than 0.4 cc/m2 , or less than 0.2 cc/m2 . In some examples the fitting can include an oxygen transmission rate in a range between about 0.8 cc/m2 and about 1 cc/m2, between about 0.6 cc/m2 and about 0.4 cc/m2 , or between about 0.4 cc/m2 and about 0.2 cc/m2.

In some examples, and as explained in greater detail below, multi-layer coextrusion of the liner can include a process in which two or more plastic materials are extruded as one. In a standard monolayer sheet extrusion process, one material is fed and extruded through a die. The coextrusion process involves multiple extruders and multiple materials (depending on the structure), and the molten material can be channeled through melt pipes to create a laminar flow for the coextrusion feed block and die technology to weld the extrudate components into a one-piece structure. When multiple material layers are combined, the end result yields in a multi-layer structure deriving distinct properties from each material used in the structure. During the extrusion of these plastics materials, the cooling is achieved by feeding the material through the cooling rolls. The cooling rolls deliver the cooling in addition to determining the sheet thickness.

When the fitting 100 is coupled to the liner 106, in some examples, the fitting 100 can be heat sealed to the liner. Plastics such as polyethylene and polypropylene are thermo-reactive plastics, that at the right temperature (about 140° F.), can have two layers pressed and melded together by a heated machine. Polyethylene has a heat-sealing temperature of 140 degrees Fahrenheit, or 76.6 degrees Celsius. Polypropylene seals at roughly 248-253 degrees Fahrenheit, or 120-123 degrees Celsius. Temperature cooldown and seal time are also important factors, and thicker bags will require more heat and often have a longer seal and cooldown period.

In some examples, the fitting 100 can be coupled to the liner 106 by thermoforming. While closely related, “heat sealed” refers specifically to the process of fusing two plastic layers together using heat and pressure to create a seal, while “thermoformed” describes the broader process of heating a plastic sheet to mold it into a desired shape. In some examples, the fitting 100 and the liner 106 can be thermoset. Thermosets will not melt even when exposed to extremely high temperatures. Common examples of thermoset plastics and polymers include epoxy, silicone, polyurethane and phenolic. In addition, some materials such as polyester can occur in both thermoplastic and thermoset.

In some examples, the fitting 100 can be coupled to the liner 106 by a sealant. In some examples, the sealant can be an epoxy. In some examples, the sealant can include an ultrasonic weld or hot plate weld. In other examples, the fitting 100 can be coupled to the liner 106 by infrared welding or laser welding. In other examples, the fitting 100 can be coupled to the liner 106 by overmolding. Overmolding, sometimes referred to as two-shot molding, is a two-step process. First, a base component such as the liner 106 is molded and allowed to cure. Then, the fitting 100 can be molded directly on top of the first to create a single solid piece.

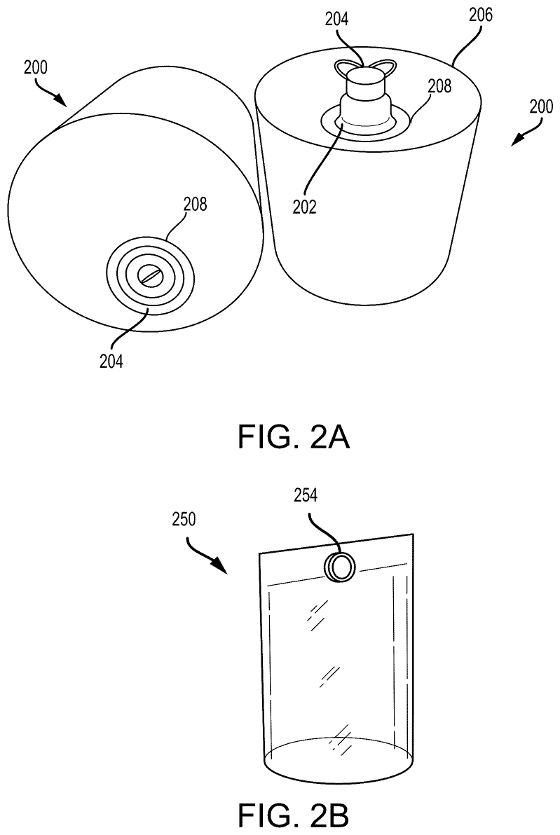

Referring to FIG. 2A, a container 200 is shown. In some examples, the container 200 includes a fitting 202 coupled to the container 200. The fitting 202 includes an extendable connector. In some examples, the fitting further includes a cap 204. The cap 204 can be a threaded connector or a press-fit connector. The fitting 202 can be coupled to a container liner 206 at an interface 208. In some examples, the fitting 202 can be coupled to the container liner 206 via any of the above disclosed methods and any suitable method known in the art. The extendable connector is shown extended and retracted, which can be for more compact storage of the container 200.

Referring to FIG. 2B, a liner 250 is shown. In some examples, the liner 250 can include multiple layers. The liner 250 can also include a fitting 254. The fitting includes a press-fit fitting 254. In some examples, the fitting 254 can include a cap or a plug (not shown). The fitting 254 can be coupled to the liner 250 via any of the above disclosed methods and any suitable method known in the art.

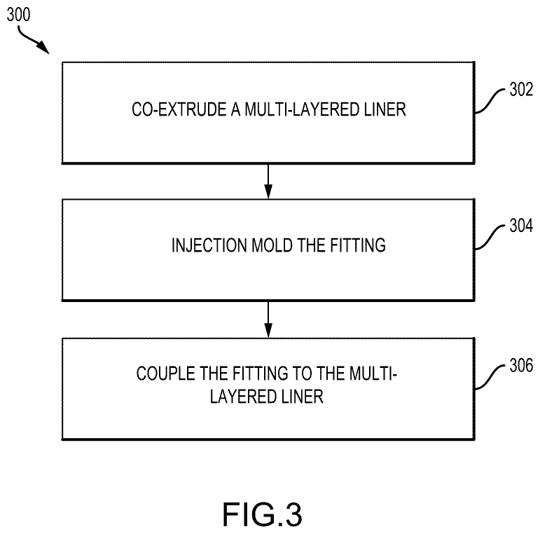

FIG. 3 is a block flow diagram for a method 300 for forming a multi-layer liner with a fitting. The method 300 for forming a multi-layer liner with a fitting can utilize use any of the containers and liners or fitting assemblies disclosed herein. The method 300 may include block 302, which includes co-extruding the multi-layered liner. In some examples, the multi-layered liner can include at least two layers. In some examples, co-extruding the multi-layered liner comprises combining at least a polyethylene and ethylene vinyl alcohol into a single product by forcing them through a die. In some examples, at least one layer of the multi-layer liner comprises greater than 20 wt. % of ethylene vinyl alcohol. Block 302 may be followed by block 304, which includes injection molding the fitting. In some examples, the fitting can include greater than 20 wt. % of ethylene vinyl alcohol. In some examples, the injection molding injects the components of the fitting that are molten by heat into a mold, and then cooling and solidifying the components. An example injection molding system can include a clamping unit and an injection unit. The functions of the clamping unit are opening and closing a die, and the ejection of products. There are two types of clamping methods, a toggle type, and a straight-hydraulic type in which a mold is directly opened and closed with a hydraulic cylinder. The functions of the injection unit are to melt plastic by heat and then to inject molten plastic into the mold. While molten plastic is flowing in a mold, the machine controls the moving speed of the injection speed and dwell pressure after molten plastic fills out cavities.

The method 300 can also include the block 306, which includes coupling the fitting to the multi-layered liner. In some examples, coupling the fitting to the multi-layered liner can include at least one of thermoforming, heat-sealing, or thermosetting the multi-layer liner and the fitting together. Thus, by completing blocks 302 through 306, a fitting and liner, such as fitting 100 coupled to liner 106, can be organized, assembled, and prepared for operation.

Blocks 302, 304, and 306 of the method 300 are shown for illustrative purposes. For example, all acts or blocks illustrated of the method 300 may be performed in different orders, split into multiple acts, modified, supplemented, or combined. In an example, one or more of the acts of the method 300 may be omitted from the method 300. Any of the acts of the method 300 can include using any of the sensor assemblies or systems disclosed herein.

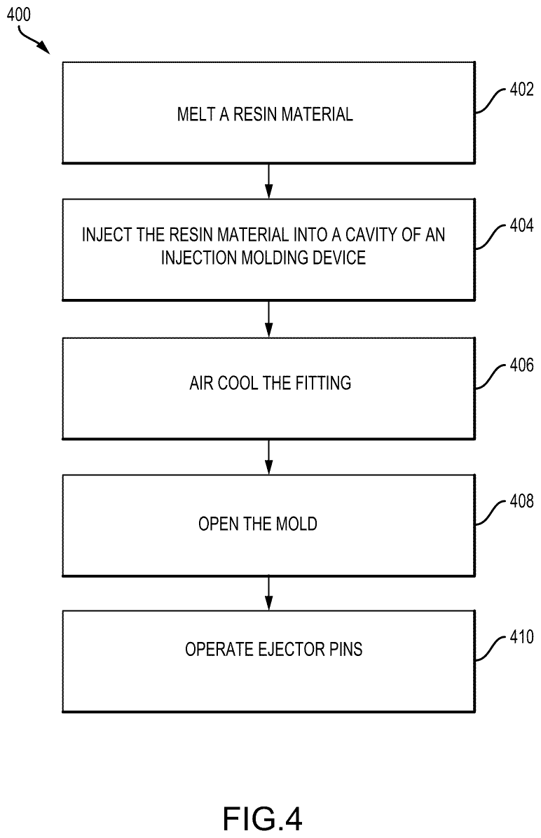

FIG. 4 is a block flow diagram for a method 400 of forming a fitting. The method 400 for forming a fitting can utilize use any of the fittings or fitting assemblies disclosed herein. The method 400 may include block 402, which includes melting a resin material. In some examples, the resin material can include a polyethylene and an ethylene vinyl alcohol. In some examples, the resin material can include at least one of a high-density polyethylene, polypropylene, or a polyamide. The method can also include block 404, which includes injecting the resin material into a cavity of an injection molding device to form a fitting. In some examples, the fitting includes greater than 20 wt. % of ethylene vinyl alcohol. In some examples, the fitting includes an oxygen transmission rate of less than 0.16 cc/m².

In some examples, the method 400 further includes act 406, which includes air cooling the fitting. Since cooling time accounts for about 70% to 80% of the entire molding cycle, a well-designed cooling system can greatly shorten the molding time, increase injection molding productivity, and reduce costs. Air cooling is a relatively ideal cooling method. Unlike water cooling, it does not require tight pipeline sealing, there is no waste of resources, it can cool molds with temperatures higher than 100° C., and the cooling speed can be determined by the flow rate of gas.

Act 406 can be followed by act 408, which includes opening the mold. Then the method can include act 410, which includes operating ejector pins to contact the fitting and release the fitting from the mold. An ejector pin is an ejector system that pushes the molded part out of the mold cavity after injection. Alongside ejector systems such as ejector blades and blocks, ejector allows efficient parts removal after molding.

While various aspects and embodiments have been disclosed herein, other aspects and embodiments are contemplated. The various aspects and embodiments disclosed herein are for purposes of illustration and are not intended to be limiting.

Terms of degree (e.g., “about,” “substantially,” “generally,” etc.) indicate structurally or functionally insignificant variations. In an example, when the term of degree is included with a term indicating quantity, the term of degree is interpreted to mean ±10%, ±5%, or +2% of the term indicating quantity. Further, the terms “less than,” “or less,” “greater than,” “more than,” or “or more” include, as an endpoint, the value that is modified by the terms “less than,” “or less,” “greater than,” “more than,” or “or more.” In an example, when the term of degree is used to modify a shape, the term of degree indicates that the shape being modified by the term of degree has the appearance of the disclosed shape. For instance, the term of degree may be used to indicate that the shape may have rounded corners instead of sharp corners, curved edges instead of straight edges, one or more protrusions extending therefrom, is oblong, is the same as the disclosed shape, etc.

As used herein, conjunctive terms (e.g., “and”) and disjunctive terms (e.g., “or”) should be read as being interchangeable (e.g., “and/or”) whenever possible. Furthermore, in claims reciting a selection from a list of elements following the phrase “at least one of,” usage of “and” (e.g., “at least one of A and B”) requires at least one of each of the listed elements (i.e., at least one of A and at least one of B), and usage of “or” (e.g., “at least one of A or B”) requires at least one of any individual listed element (i.e., at least one of A or at least one of B). It is noted that, when described or recited herein, the use of the articles such as “a” or “an” is not considered to be limiting to only one, but instead is intended to mean one or more unless otherwise specifically noted herein.

What is claimed is:

1. A fitting configured to be coupled to a container liner, the fitting comprising:
a plastic composite comprising a chemical resistant material, wherein the fitting is injection molded.

2. The fitting of claim 1, wherein the chemical resistant material comprises ethylene vinyl alcohol.

3. The fitting of claim 1, wherein the plastic composite comprises at least one of a nylon, low-density polyethylene, linear low-density polyethylene a high-density polyethylene, polypropylene, or a polyamide.

4. The fitting of claim 1, wherein the fitting is heat sealed to the liner.

5. The fitting of claim 1, wherein the fitting and the liner are thermoformed.

6. The fitting of claim 1, wherein the fitting further comprises a plug or cap that includes ethylene vinyl alcohol.

7. The fitting of claim 1, wherein the fitting comprises a threaded connector.

8. The fitting of claim 1, wherein the fitting comprises an extendable connector.

9. The fitting of claim 1, wherein the fitting comprises a press-fit connector.

10. The fitting of claim 1, wherein the container liner comprises at least two layers.

11. The fitting of claim 1, wherein the container liner comprises at least one of ethylene vinyl alcohol and polyamide.

12. The fitting of claim 1, wherein the fitting comprises an oxygen transmission rate of less than about 1 cc/m².

13. A method for forming a multi-layer liner with a fitting, comprising:
co-extruding the multi-layered liner;
injection molding the fitting, wherein the fitting comprises greater than about 10 wt. % of ethylene vinyl alcohol; and
coupling the fitting to the multi-layered liner.

14. The method of claim 13, wherein co-extruding the multi-layered liner comprises combining at least a polyethylene and ethylene vinyl alcohol into a single product by forcing them through a die.

15. The method of claim 13, wherein at least one layer of the multi-layer liner comprises greater than about 10 wt. % of ethylene vinyl alcohol.

16. The method of claim 13, wherein coupling the fitting to the multi-layered liner comprises at least one of thermoforming, heat-sealing, or thermosetting the multi-layer liner and the fitting together.

17. A method for forming a fitting, the method comprising:
melting a resin material, wherein the resin material comprises a polyethylene and an ethylene vinyl alcohol;
injecting the resin material into a cavity of an injection molding device to form the fitting, wherein the fitting comprises greater than about 10 wt. % of ethylene vinyl alcohol.

18. The method of claim 17, wherein the fitting comprises an oxygen transmission rate of less than about 1 cc/m².

19. The method of claim 17, further comprising:
air cooling the fitting;
opening the injection molding device; and
operating ejector pins to contact the fitting and release the fitting from the injection molding device.

20. The method of claim 17, wherein the fitting comprises at least one of a threaded connector, an extendable connector, or a press-fit connector.
